(19) United States
(12) Patent Application Publication
(10) Pub. No.: US 2015/0051998 A1
(43) Pub. Date: Feb. 19, 2015

(54) SYSTEMS AND METHODS FOR PRESENTING BAND CONFIGURATIONS

(71) Applicant: BLUE NILE, INC., Seattle, WA (US)

(72) Inventors: Steven Gire, Seattle, WA (US); Jonathan Sainsbury, Seattle, WA (US); Benjamin Marvin Bostow, Seattle, WA (US)

(73) Assignee: BLUE NILE, INC., Seattle, WA (US)

(21) Appl. No.: 14/040,015

(22) Filed: Sep. 27, 2013

Related U.S. Application Data
(63) Continuation of application No. 13/969,420, filed on Aug. 16, 2013.

(51) Int. Cl. G06Q 30/06

(52) U.S. Cl. CPC G06Q 30/0621
USPC 705/26.5

(57) ABSTRACT

The disclosed embodiments relate to and the presentation thereof in a computer interface. Particularly, some embodiments facilitate the selection of combinations by a user. The combination may be, e.g., an engagement and a wedding ring. In some embodiments, an event-triggering architecture in the interface facilitates the selective updating of interface elements in a manner paralleling the desired process path traversed by the user.

### CROSS-REFERENCE TO RELATED APPLICATION

This application is a continuation of U.S. patent application Ser. No. 13/969,420, entitled “SYSTEMS AND METHODS FOR PRESENTING BAND CONFIGURATIONS”, filed on Aug. 16, 2013, the contents of which are incorporated herein by reference in their entirety.

### FIELD OF THE INVENTION

Various of the disclosed embodiments disclose systems and methods for presenting a user with configurations of elements, such as engagement and wedding rings.

### BACKGROUND

Many of life's most significant occasions are accompanied by the selection of jewelry. Weddings and engagements, for example, climax and/or are initiated with the presentation or exchange of rings. Selecting appropriate rings for such an occasion is accordingly of the utmost importance, as the rings function as much more than mere accessories to a social exercise. Rather, as physical manifestations of an emotional bond, both purchaser and recipient often accord their ring immense personal significance well beyond its monetary and social value. The ring's success as such a metaphor, however, depends heavily upon the ritualized manner in which it is presented, received, and worn. If a wedding ring is presented which incongruously matches its engagement counterpart, or which is difficult or painful to wear, the metaphor may fail, or worse, be adversely construed by the recipient against the purchaser.

Consequently, purchasers regularly expend considerable time and effort to select rings which complement one another successfully, while still achieving the intended personal effect. Before the Internet, recourse to an establishment specifically designed for that purpose was often necessary. The advent of the Internet has mitigated such a necessity, but instead substituted a panoply of choices. Such diverse options, presented indiscriminately, can further complicate the selection process. Selecting appropriate rings, let alone rings which complement one another in a desired fashion, remains difficult and often impossible under these circumstances. The problem is even more difficult as the purchaser and recipient may not be able to anticipate the effect of a combination until having viewed the rings together as was done in the physical establishment.

Accordingly, there exists a need for online systems and methods that facilitate the selection of complementary rings and jewelry, as well as other paired items (e.g. clothing) whose aesthetic value depends upon their combination. Furthermore, such systems and methods should be amenable to rapid permutations so that both purchaser and/or recipient can assess the effect of each combination in relation to their personal expectations. There further exists a need for the system to facilitate rapid integration of new functionality and to complement the structure of stored data and the desired process path of the user.

### BRIEF DESCRIPTION OF THE DRAWINGS

One or more embodiments of the present disclosure are illustrated by way of example and not limitation in the figures of the accompanying drawings, in which like references indicate similar elements.

FIG. 1 illustrates a topology for presenting a user with an interface for selecting and viewing (e.g. ring) combinations.

FIG. 2 is a flow diagram generally depicting an exemplary process by which a user may select a (e.g. rings) combination as may be implemented in some embodiments.

FIG. 3 is a screenshot of an initial combination representation of “ghost” ring elements as may be implemented in some embodiments.

FIG. 4 is a screenshot of a “style” grouping of ring elements following selection of a “Vintage” style as may be implemented in some embodiments.

FIG. 5 is a screenshot illustrating how a pair of selected pieces would look paired together in accordance with some embodiments of the disclosed technology. For example, the combination may be presented following selection of the “Pave Diamond Engagement Ring” primary element.

FIG. 6 is a screenshot depicting how one selected piece of would appear with another selection in accordance with an embodiment of the disclosed technology. For example, the combination may be presented following selection of the “Pave Sapphire and Diamond” complementary element as may be implemented in some embodiments.

FIG. 7 is another screenshot illustrating how a pair of selected elements may appear together in some embodiments. For example, such a combination may be presented following selection of the “Trio Princess Pave Diamond Engagement Ring” element as may be implemented in some embodiments.

FIG. 8 is a screenshot illustrating a primary ring detail and construction interface as may be implemented in some embodiments.

FIG. 9 is a screenshot of a secondary ring detail interface as may be implemented in some embodiments.

FIG. 10 is a block-diagram depiction of element and metadata relations in, e.g., a JSON, XML, or SQL hierarchy, as may be implemented in the database of some embodiments.

FIG. 11 is block diagram depicting event and trigger relations as may be implemented in some embodiments.

FIG. 12 shows a diagrammatic representation of a machine in the example form of a computer system within which a set of instructions for causing the machine to perform any one or more of the methodologies discussed herein may be executed.

Those skilled in the art will appreciate that the logic and process steps illustrated in the various flow diagrams discussed below may be altered in a variety of ways. For example, the order of the logic may be rearranged, substeps may be performed in parallel, illustrated logic may be omitted, other logic may be included, etc. One will recognize that certain steps may be consolidated into a single step and that actions represented by a single step may be alternatively represented as a collection of substeps. The figures are designed to make the disclosed concepts more comprehensible to a human reader. Those skilled in the art will appreciate that actual data structures used to store this information may differ from the figures and/or tables shown, in that they, for example, may be organized in a different manner; may contain more or less information than shown; may be compressed and/or encrypted; etc.

### DETAILED DESCRIPTION

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are, references to the same embodiment; and, such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

### System Topology Overview

Various embodiments of the present disclosure include systems and methods for presenting users with combinations, such as wedding and engagement ring combinations. Though the disclosure, via the specification text, figures, and appended code, may regularly reference rings, bands, and the like, to facilitate explanation, one will recognize that the disclosed embodiments apply to anything capable of being selected in combination. Accordingly, ear rings, bracelets, necklaces, broaches, clothing, shoes, watch-bands, etc. may all be displayed and selected mutatis mutandis via the disclosed embodiments. Similarly, many of the embodiments may be employed with elements other than jewelry. For example, although a primary and secondary ring pair is often used for purposes of explanation, one will recognize that, e.g., clothing combinations may instead be substituted, such as sock and shoe selection, shirt and pants, etc. Indeed, these embodiments may apply to any pairing of items where the selection of the second item is predicated upon the selection of the first, or vice versa, particularly where the aesthetic value of the two items is correlated with one another. Similarly, though the below examples are often discussed in relation to a browser and HTML elements, one will recognize that the functionality may likewise be implemented in a regular application (e.g., a program on a mobile device specifically designed for making purchases) with corresponding graphics and inputs.

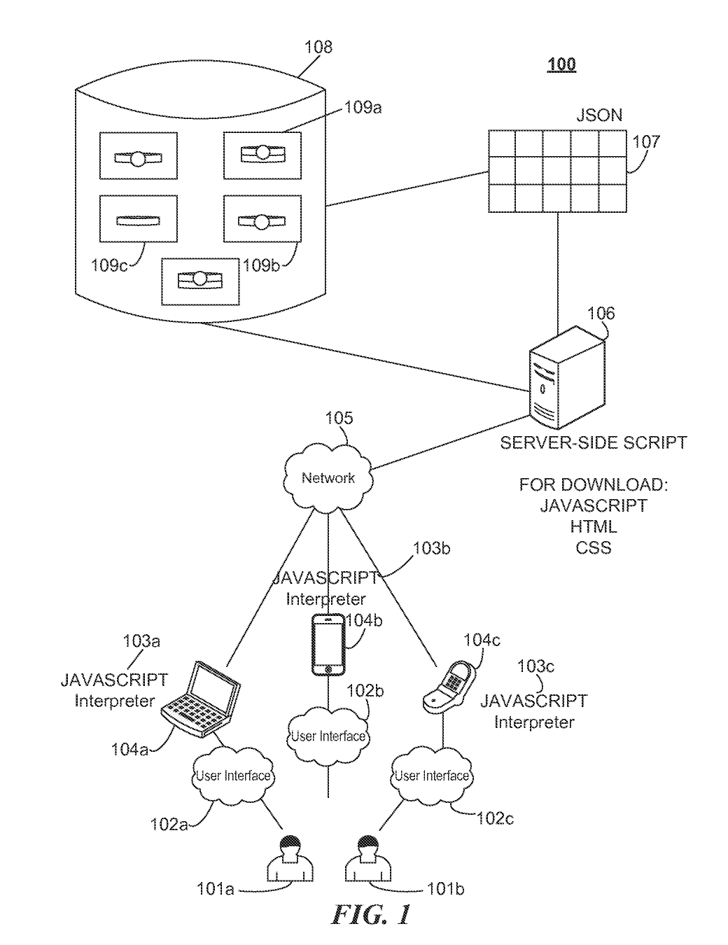

FIG. 1 illustrates a topology 100 for presenting a user with an interface for selecting and viewing combinations, such as ring combinations. One or more users 101a-b, e.g. a purchaser and a recipient, may view an application or website via user interfaces 102a-c. The user interface 102a-c may appear in any suitable computer device 104a-c, e.g., a personal digital assistant, a mobile phone, a laptop, desktop, etc. For example, the user interfaces 102a-c may appear in a browser. In some embodiments, the browser software may include a JAVASCRIPT interpreter 103a-c program running on the user's device, though one will recognize that the same or similar functionality described herein can be achieved with other languages, e.g., objective-C, C++, Java, Python, Perl, etc. Though many of the disclosed examples refer to a browser for ease of explanation, one will recognize that any suitable software interface, for example a mobile application not specifically designed for internet browsing but still supporting network communication, may likewise suffice.

Each device 104a-c may receive information over a wired or wireless network 105, which may be, e.g., the Internet. A server system 106 may be in communication with the devices 104a-c via the network 105. Server system 106 may be managed by a vendor of rings and other jewelry. Server system 106 may include, or be in communication with, a database table of information 107. In the depicted example, the information includes a collection of JAVASCRIPT Object Notation (JSON) objects. Each JSON object may store information regarding relationships between primary and secondary rings. In a database 108 stored on server 106 or in communication with server 106, may be stored a plurality of images 109a-c. The images 109a-c can include images of primary rings 109b, images of secondary rings 109c and images of ring combinations 109b (or more generally, primary and secondary items for consideration and selection). In some embodiments, every possible combination of primary and secondary rings is depicted in the database 108. The combined images may be dynamically generated from images of the individual rings or may be captured by placing real-world exemplars together. Images of real-world exemplars may be created to demonstrate the visual effect of the rings in combination when worn as well as practical features such as their relative spacing.

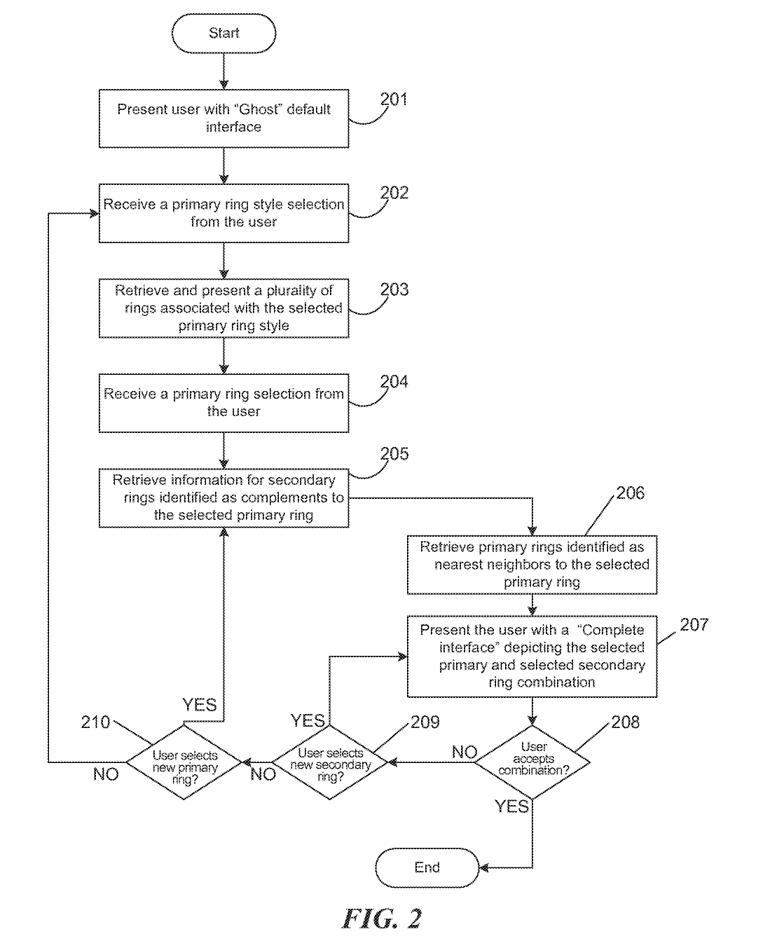

FIG. 2 is a flow diagram generally depicting an exemplary process 200 by a computer system manages an interface with which a user may select a (e.g. rings) combination as may be implemented in some embodiments. Though the steps are depicted in a particular order for ease of explanation, one will readily recognize that the steps may be rearranged to achieve the similar or the same functionality.

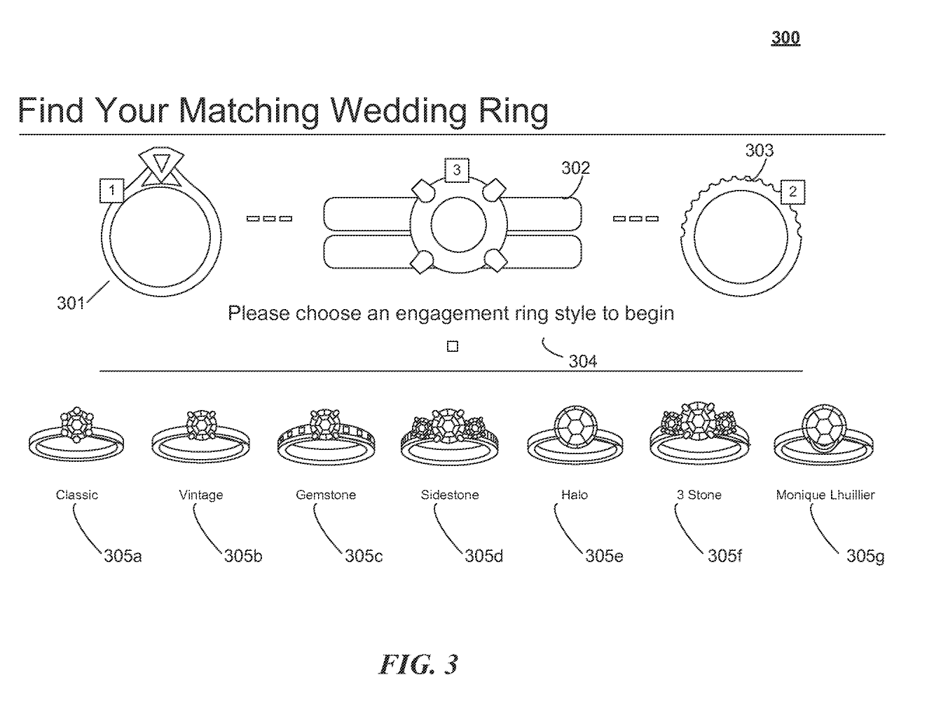

At block 201 the system presents the user with a “Ghost” default interface, e.g. such as is depicted in FIG. 3. This default interface may be presented in a browser of a user device as a combination of hypertext markup language (HTML), cascading style sheets (CSS), and JAVASCRIPT. The default interface may include images or icons that serve to orient the reader by depicting an outline of the elements (e.g., rings) and their presentation following a selection by the user.

At block 202, the system may receive a primary ring style selection from the user, e.g., via a GET or POST request following selection of an icon on the default interface.

At block 203, the system may retrieve and present a plurality of rings associated with the selected primary ring style. For example, the server 106 may consult an SQL database, a JSON file, etc., or the like wherein ring data and relationships may be stored. The results may be presented, e.g., as an one or two dimensional array or matrix of images depicting the available primary rings associated with the selected style. Each image may be associated with a GET or POST request reflecting parameters associated with the ring. For example, the request may be of the following form (described in greater detail below):
http://www.bluenile.com/wedding-rings/find-your-matching-wedding-ring?track=NavWedBndMat#setting!9917

At block 204, the system receives a primary ring selection from a user, e.g., following the user's selection of an icon presented in their browser at block 203.

At block 205, the system may retrieve information for secondary rings identified as complements to the selected primary ring. For example, the server 106 may consult a SQL database, a JSON file, etc., which may be the same or different as the database contacted at block 203. In some embodiments, all the possibly relevant information is instead retrieved at block 203. For example, having received a primary ring selection, the system retrieves data regarding nearest neighbors as well as information for all possible complements to the selected primary ring.

At block 206, the system may retrieve primary rings identified as “nearest neighbors” or counterparts, to the selected primary ring. For example, within a style having some thirty rings, seven of the rings may share a similar diamond setting structure. This similarity may be reflected in the JSON or SQL data. Accordingly, selection of one of the seven rings may result in the retrieval of representations of the remaining six counterparts. In some embodiments, the selection of nearest neighbors may be influenced by marketing and/or inventory systems. For example, when demand for a particular ring rises or falls, or when the ring is being sold at a discounted value, the administrator of the server 106, or corresponding databases may adjust the relational information so that certain rings are preferentially included in the group of nearest neighbors.

At block 207, the system presents the user with a “complete interface”, e.g., one that displays actual ring images in lieu of the placeholders in the “ghost” interface. This complete interface may depict the selected primary ring and a default complementary ring from the group retrieved at block 205.

At block 208, the system may receive an indication from the user that they accept the combination. If so, the selection process may end and the system proceeds to a payment process as is known in the art.

If the user does not accept the selection, however, at block 209, the user may have instead selected a new secondary ring. If so, the server updates the interface at block 207 to reflect the new combination. In some embodiments, this may be accomplished using the event-trigger architecture described in greater detail below.

Similarly, if at block 210 the user decides to select a new primary ring, the system may retrieve a new primary ring at block 205 and recreate the interface as previously described. In some embodiments, this may be accomplished without requesting the entire interface from the server again, but instead using the event-trigger architecture described in greater detail below, which may make individual requests for data or rely from the server or from a previously returned data object. In some embodiments, a user may also select an entirely new style at block 202 and begin the process anew. In some embodiments, the user can save a combination for subsequent review and comparison with a newly generated combination, possibly having a different primary style.

FIG. 3 is a screenshot of an initial combination representation of “ghost” ring elements in a “ghost” interface 300 as may be implemented in some embodiments. A primary ring placeholder 301, combination placeholder 302, and secondary ring placeholder 303 may instruct the user as to the sequence of inputs required to generate a combination. An invitation 304 may also be provided to further direct the user. A plurality of exemplary rings 305a-g may be displayed to represent each of the possible primary styles available for selection. The browser interface may be generated using a template interface, e.g., HandleBars or the like. CSS and HTML elements may be used, alone or in conjunction with software packages such as JQuery to place the elements on the page.

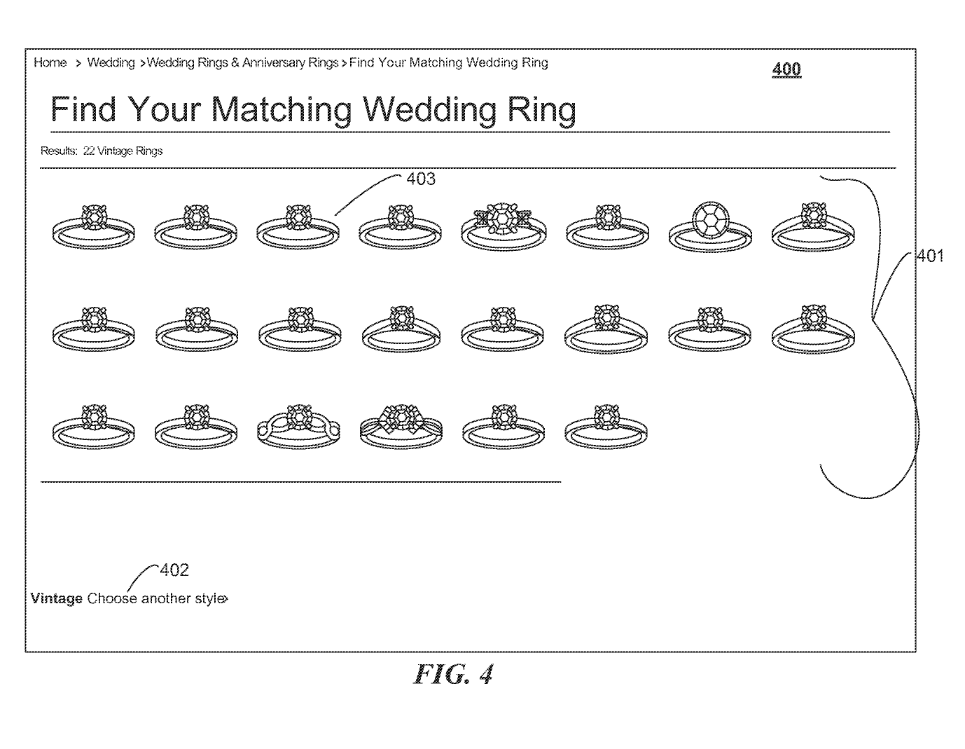

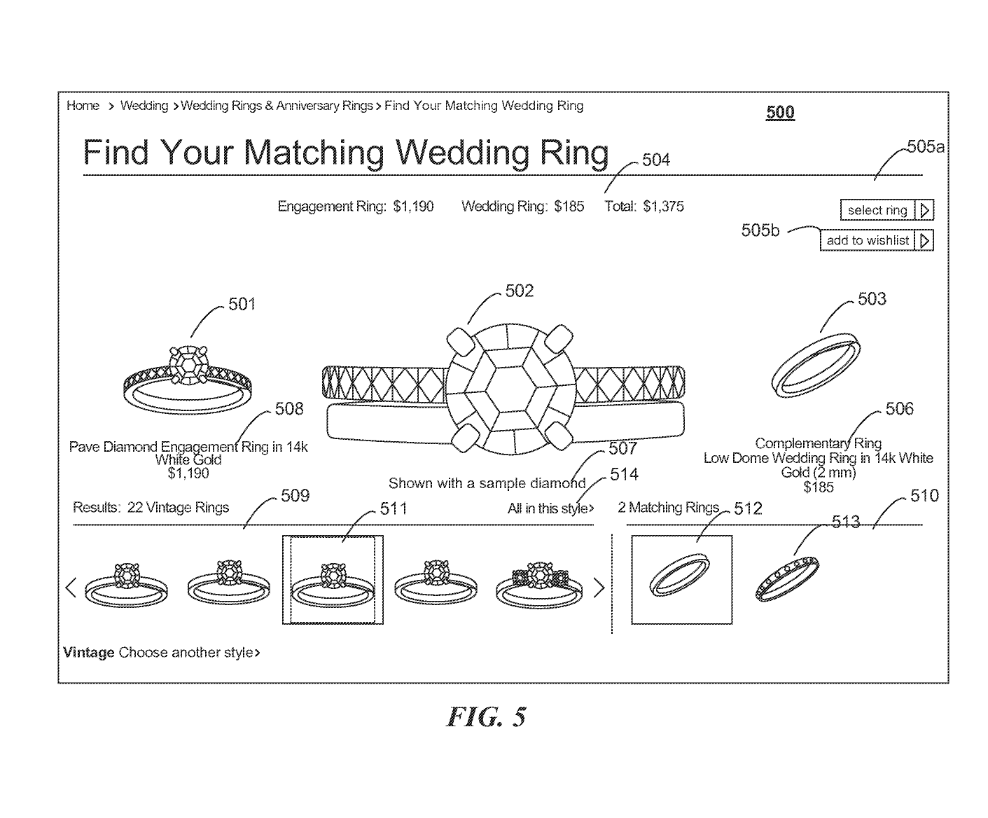

FIG. 4 is a screenshot of a “style” grouping of ring elements following selection of a “Vintage” style 305b as may be implemented in some embodiments. The “vintage” style icon 305b may comprise an image “img” element in conjunction with a hypertext reference “href” including GET parameters. The parameters may inform a server-side script which style of rings 401 to display. The user may return to the original ghost interface by selecting the style input 402. Again, each ring 401 may comprise an img and href reference or other suitable indicator. A user may select the icon 403 representing a “Pave Diamond Engagement Ring” and be then presented with the interface of FIG. 5.

FIG. 5 is an exemplary screenshot illustrating how a pair of selected pieces would look paired together in accordance with some embodiments of the disclosed technology. This particular screenshot depicts a combination representation following selection of the “Pave Diamond Engagement Ring” element 403 as may be implemented in some embodiments. In this “complete” interface 500 the interface may display the primary ring selection 501, the combination 502, and the secondary ring selection 503. In this example, the primary ring 501 is an engagement ring and the secondary ring 503 is a wedding ring with the two being designed to be worn simultaneously on one finger.

The interface 500 may include detailed information describing the primary ring 508, information describing the secondary ring 506, and a summary of the price breakdown 504. These elements may be populated dynamically using an AJAX query to the server or using an object (e.g. a JSON object) previously retrieved from the server when populating the style interface of FIG. 3. For example, the browser may not reload the entire page following selection of a new primary or secondary ring, but may instead retrieve only the relevant information and repopulate the corresponding elements. As described in greater detail below, an event-trigger arrangement may be used to complement the unique efficiencies of the ring information data structure (e.g., the JSON objects). By selecting icon 505a the user may begin the purchasing process. By selecting icon 505b the user may instead save the combination for future review and comparison with other combinations.

A primary region 509 may be used to display the nearest neighbors of the selected primary ring 511. The HTML element depicting primary ring 511 may be associated with a link containing information explaining how to perform an associated action. For example, the link may appear as:
“http://www.bluenile.com/wedding-rings/find-your-matching-wedding-ring?track=NavWedBndMat#setting!9917”
   In this example, the path generally indicates where in the directory structure of server 106 the ring selection application is located (“http://www.bluenile.com/wedding-rings/find-your-matching-wedding-ring”). Parameters “track=NavWedBndMat#setting!9917” may be appended to the path. The “track” parameter may indicate which, of several, ring selection and creation tools are to be presented to the user and to receive the following parameters. The parameters following “#” may indicate particular information for the tool. An exclamation, or other delimiter, may be used to separate parameters. The first parameter may indicate whether the selected ring is a primary (“setting”) ring, or a secondary (“band”) ring. The second parameter (“9917”) may indicate the identification number of the ring.

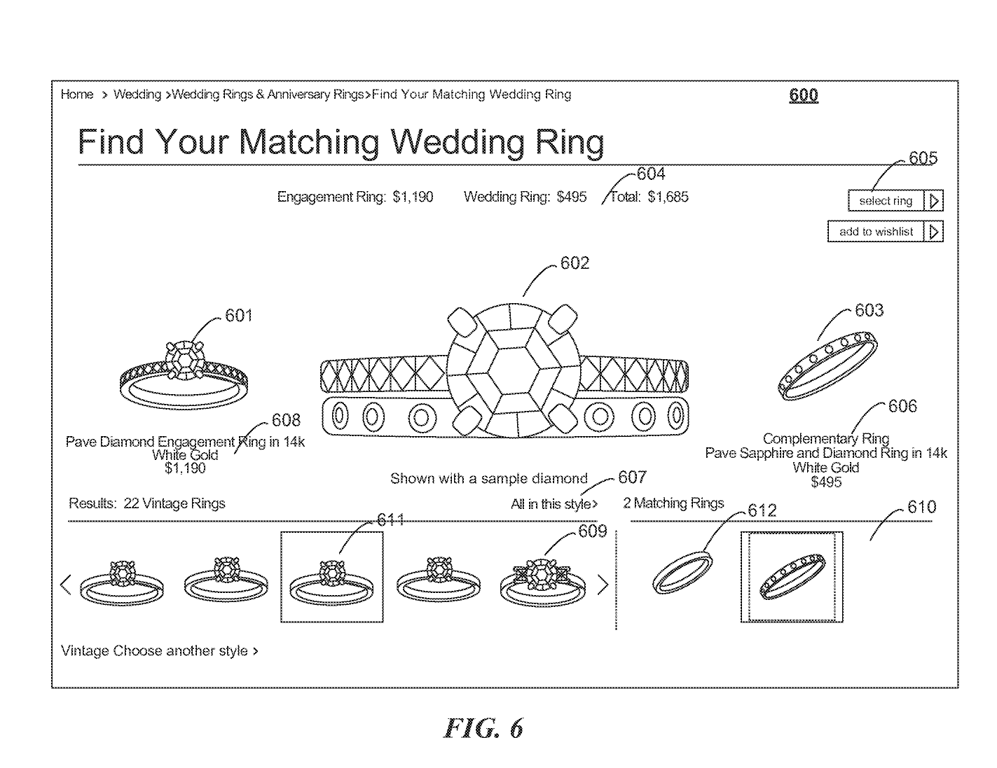

A matching secondary, or band, region 510 may depict the corresponding secondary rings and the currently selected secondary ring 512. Following selection of the “Pave Sapphire and Diamond” ring 513 the user may be presented with the interface of FIG. 6. The HTML element depicting “Pave Sapphire and Diamond” ring 513 may also be associated with a link containing information explaining how to perform an associated action. For example, the link may appear as:
“http://www.bluenile.com/wedding-rings/find-your-matching-wedding-ring?track=NavWedBndMat#band!17387”
   As discussed above the “band” parameter may indicate that the “17387” parameter refers to a secondary ring ID.

FIG. 6 is a screenshot 600 depicting how one selected piece of would appear with another selection in accordance with an embodiment of the disclosed technology. This particular screenshot depicts a combination representation following selection of the “Pave Sapphire and Diamond” complementary element as may be implemented in some embodiments. In this example, the browser may update only the HTML elements related to the new information. For example, combination depiction 602, the secondary ring depiction 603, secondary ring information 606, and pricing information 604 may each be replaced with information retrieved via an AJAX request to the server. Alternatively, the system may harvest a previously acquired data object, such as a JSON file, containing all the relevant information. Such selective updating may proceed via event-trigger cascades described in greater detail below.

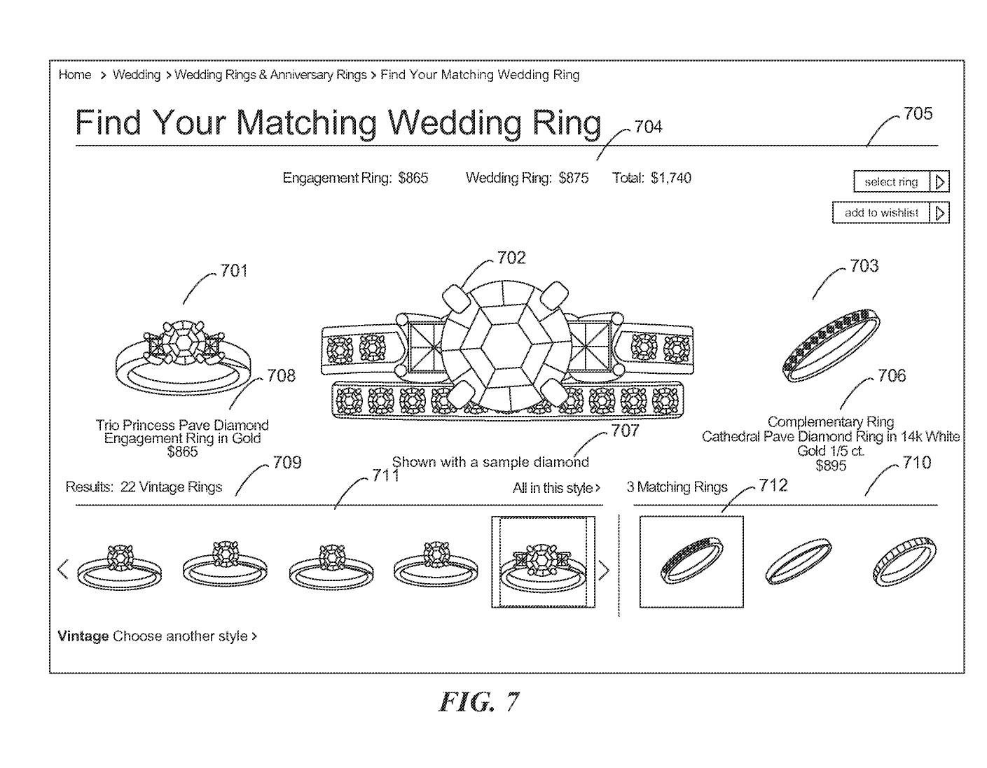

Rather than select a secondary ring, the user may select a new primary ring, such as “Trio Princess Pave Diamond Engagement Ring” 609. FIG. 7 is another screenshot illustrating how a pair of selected elements may appear together in some embodiments. In this particular example, the screenshot depicts a combination representation following selection of the “Trio Princess Pave Diamond Engagement Ring” 609 element in FIG. 6 as may be implemented in some embodiments. Here, though the browser has replaced the contents of each of elements 701-4, 706, 708, 709, and 710 (either by retrieving the entire page again from the server, or performing selective event-trigger cascades as described in greater detail below). As indicated in FIG. 7 the number of secondary and primary rings associated with a primary ring selection may vary between different primary rings, styles, etc.

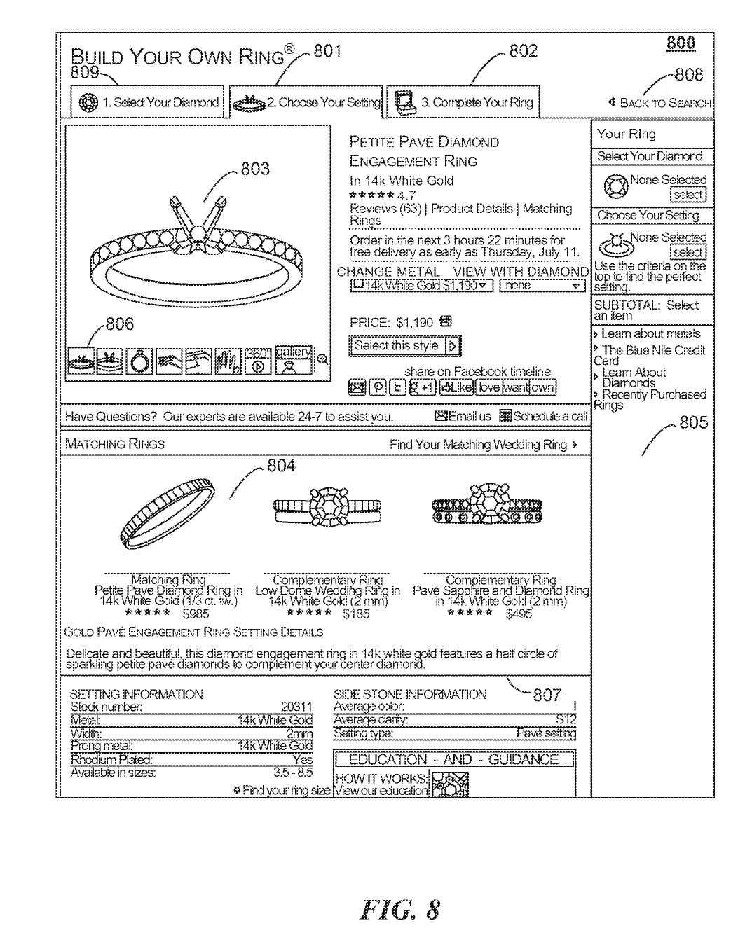

In some embodiments, the user may be able to view additional details regarding the primary and secondary rings, e.g., by selecting one of icons 701 or 703. For example, FIG. 8 is a screenshot of a primary ring detail and construction interface as may be implemented in some embodiments. Selection of icon 701 may direct a user to the interface 800. Interface 800 provides additional detail regarding the primary ring, e.g. an enlarged view of the ring setting 803, different views and animations of the ring 806, alternative matching and similar ring combinations 804, setting and sidestone details 807, and an information section regarding the ring combination 805. Panel 801 focuses on the ring's setting parameters. Panel 809 may focus on diamond selection and panel 802 may focus on ring completion. The user may return to the previous search by selecting icon 808.

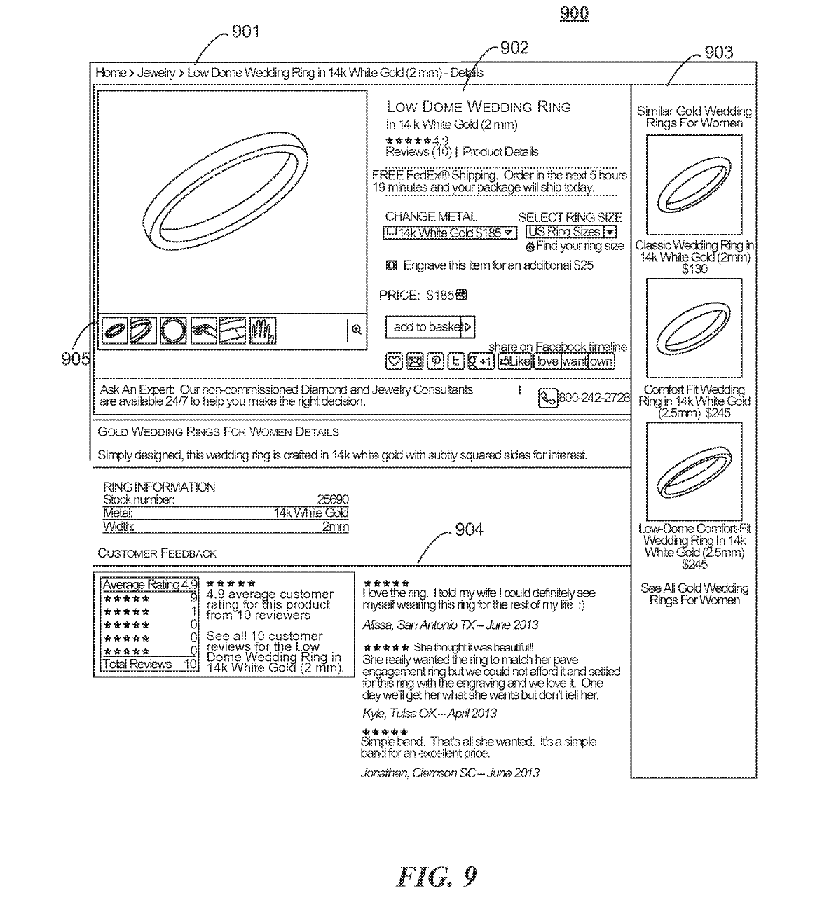

Selecting icon 703 may instead present the user with an interface depicting additional detail regarding the secondary ring. For example, FIG. 9 is a screenshot of a secondary ring detail interface 900 as may be implemented in some embodiments. The interface 900 may depict an enlarged view 901 of the secondary ring and an interface for additional views and animations 905. A more detailed description 902, a list of similar rings 903, and previous customer feedback 904 may be provided.

### Ring Database Structure

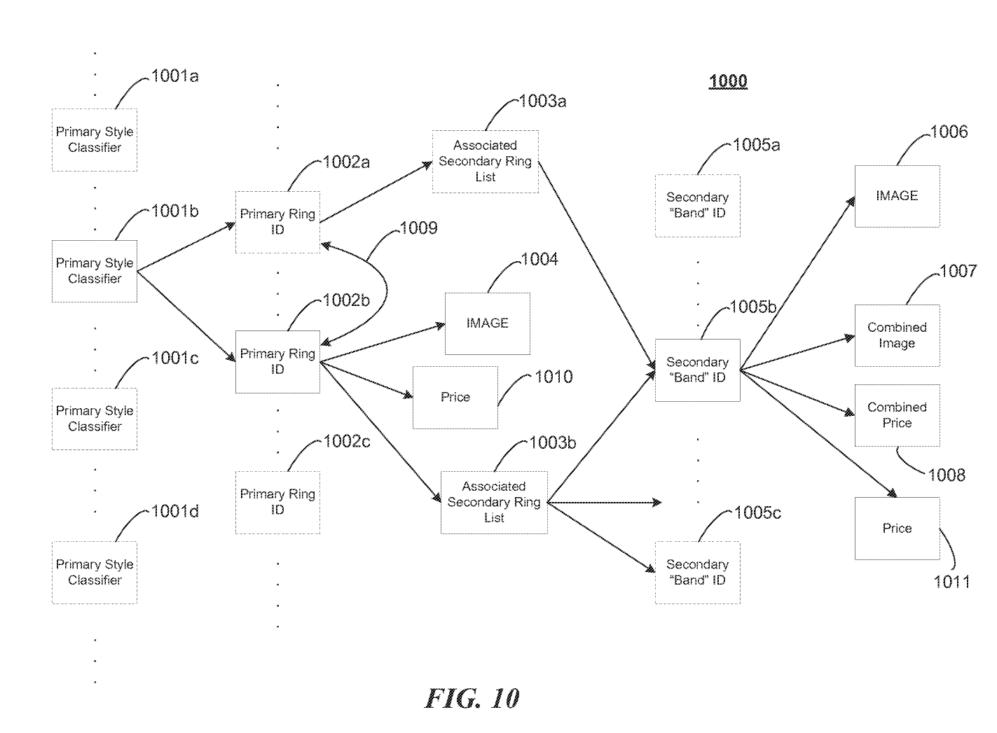

FIG. 10 is a block-diagram depiction of element and metadata relations 1000 in, e.g., a JSON, XML, or SQL hierarchy, as may be implemented in the database 107 of some embodiments. The database may include a collection of primary style classifiers 1001a-d. With reference to FIG. 3, these classifiers may reference styles such as “Classic”, “Vintage”, “Gemstone”, etc. Each style classifier 1001a-d may be associated with one or more primary ring IDs 1002a-c. The primary ring IDs 1002a-c may be associated with individual primary rings. Generally, a primary ring ID 1002a-c may belong to only one style classifier, though this need not always be the case.

Each primary ring ID 1002a-c may be associated with a secondary ring list 1003a-c. Primary ring IDs 1002a-c may also be associated 1009 with one another to reflect nearest-neighbor groupings. The association 1009 may be a total ordering among some or all of the primary rings, indicating their similarity with one another. A primary ring ID 1002b may also be associated with an image 1004, or other media, depicting the primary ring. A primary ring ID 1002b may also be associated with metadata describing the ring, such as price information 1010.

The secondary ring lists 1002a-c may themselves be associated with an ID for a secondary ring 1005a-c. The secondary ring may also be referred to as a “band” in some instances Like the primary ring IDs 1002a-c the secondary ring IDs 1005a-c may also refer to an image. A secondary ring ID 1005b may also be associated with metadata describing the ring, such as price 1011 information. In some embodiments, it is the secondary ID 1007 which is used to index combined metadata, such as a combined image 1007 and combined price 1011. The reference from the secondary ID 1005b may include a primary ID 1002b to the combined information metadata. For example, the JSON entry may be a function associated with the secondary ID which receives a primary ring ID as an input and outputs the combined metadata. Similar results may be achieved via a hash map, etc. In some embodiments, a separate data structure may depict the primary/secondary relations.

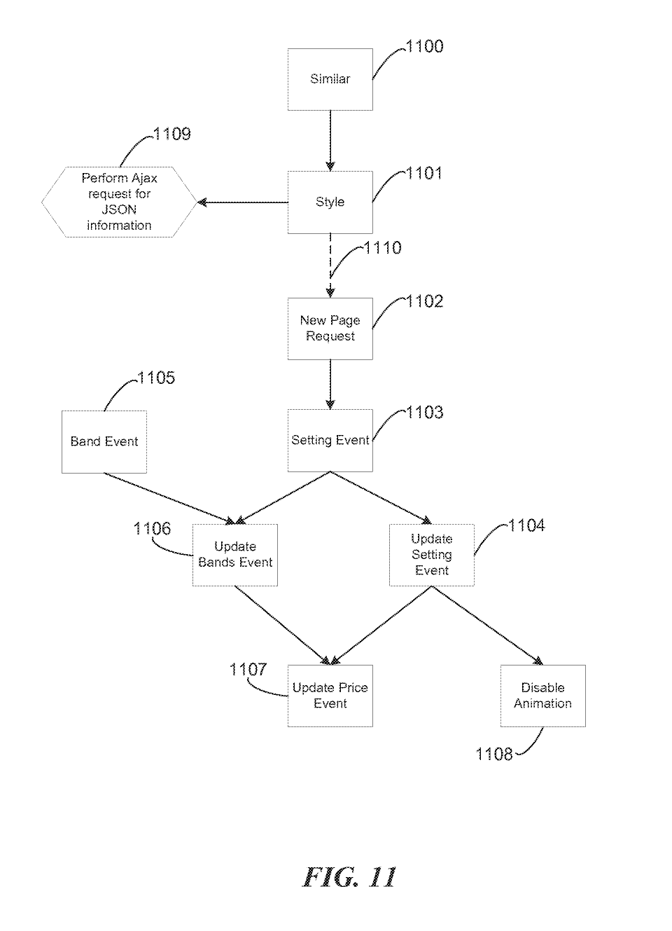

Some embodiments contemplate an “event-trigger” relation in, e.g., browser-based code that may take synergistic advantage of the ring data structure to minimize browser updates, e.g., via Ajax, while still providing the capacity to readily introduce new features and ring selection capabilities. This architecture may also ensure that the user is guided through a desired design process flow and that data is requested appropriately in conjunction with that flow. One example event-triggering system is discussed in relation to FIG. 11.

FIG. 11 is block diagram depicting event and trigger relations as may be implemented in some embodiments. In some embodiments, these relations may be implemented using an HTML template system (e.g., Handlebars), JAVASCRIPT, and CSS. For example, “on” and “trigger” functions of JQuery may be used to specify a relation between an action and an element selection. A event may be specified as the selection of an icon by the user, which has the effect of triggering a consequent action. With reference to FIG. 5, for example, the HTML element specifying “Pave Sapphire and Diamond” ring 513 may be associated with a trigger. Selection of the icon may perform one or more AJAX requests to update one or more elements on the page so that the interface depicted in FIG. 6 is presented. In some embodiments, data from a single prior AJAX request is harvested, rather than again consulting the server (e.g., the entire JSON file may have been downloaded).

As indicated by FIG. 11, the occurrence of an event may also serve as a trigger for the firing of yet another event. In this manner event cascades may be performed from the selection of a single icon. These cascades may parallel, or complement, the storage of the ring information in the JSON, SQL, or other database. Accordingly, the event cascade is narrowly tailored to synergistically operate with the database so that AJAX requests from the browser achieve optimal efficiency. This cascading structure also facilitates improvements and adjustments to the system to introduce additional features. For example, the primary ring construction tool depicted in FIG. 8 may be modified to respond to a triggering event that the user may perform on the screen of FIG. 7. For example, as suppliers are able to provide new services and adjustments to primary ring setting parameters, an administrator need not modify the interface shown in FIG. 7 to accommodate the new features. Rather, the preexisting event in the interface shown in FIG. 7 (e.g., selection of a primary ring) may trigger another event related to the interface shown in FIG. 8, such that the interface of FIG. 8 is able to be populated with the new functionality related to the primary ring. In this manner, discrete tools may be separately maintained, facilitating atomic improvements and adjustments that will not break the functionality or flow of a separate interface. Furthermore, proper selection of events within a cascade allows the same code to be reused when multiple pages are loaded. Accordingly, the disclosed embodiments provide methods for implementing this complementary functionality.

The example of FIG. 11, and the corresponding code of the sequence listing accompanying this document, is specific to one possible implementation of many possible implementations and will be understood to be provided here merely for purposes of an exemplary explanation. A “similar event” event may be defined to correspond to the initial selection of a primary ring style (e.g., selecting any of exemplary rings 305a-g), or the selection of the “all in this style” icon 514. In general, any method by which a user may arrive within a style selection of FIG. 4 may correspond to the “similar” event. Triggering of the “similar” event is coded, in this example, to automatically fire a “style” event. The “style” event performs an AJAX request 1109 for the pertinent selection. In some embodiments, this single request will retrieve all the relevant JSON information from the database. In some embodiments, information may be selectively retrieved via subsequent requests. As indicated by the “$(document).ready” behavior of the appended code sequence, the loading of a new page 1102 may trigger a setting event. Arrow 1110 indicates that a “style” event will precede a new page request event that successfully triggers a “setting” event, but that the “style” event does not itself trigger a “new page request” event (rather, it is the user who will trigger a new page request event following selection of a primary ring). The “new page request” event may be fired via a “document.onready” function as depicted in the attached code sequence.

In some embodiments, for the “New page request” event to trigger, the requesting URL must be of an appropriate form, specifying a particular ring ID. In this manner, the system ensures that the user first selects a primary style, in agreement with the organization of the JSON database, prior to requesting to view individual rings and combinations.

The remaining event cascade in this example is organized so that interface elements are only selectively updated as necessary. For example, a new page satisfying the selection of an individual ring will trigger a “setting event” 1103 which prepares the containers for receipt of information, via an “update bands” event 1106 (for the secondary ring elements, e.g. region 510) and an “update setting” event 1104 (which may update the primary ring elements, e.g. region 509). Each of the events 1104 and 1106 may automatically trigger events concerning media operation, e.g., an event disabling the animation of the ring 1108 (so that the user may restart the animation at their leisure). Each of the events 1104 and 1106 may also automatically trigger events related to the ring data they update, for example, the price 1107, presented in regions 504, 508, and 506.

Many of the events may be triggered by independent actions on the interface, such that only a portion of a larger cascade is fired. For example, selecting a secondary ring in region 510 may trigger a band event 1105 which fires only a portion of the entire cascade (e.g., updating only secondary ring related elements in the interface, such as single secondary ring image, combined image, and secondary ring price). Again, in some embodiments the information is updated from previously acquired data, such as JSON data, while in some embodiments successive AJAX requests are performed.

This event-trigger architecture also serves to direct the user through a desired selection process. In this manner, the user's options are selectively presented over time so that the selection process is less demanding and the various permutations inform, rather than complicate, the selection process.

### Computer System

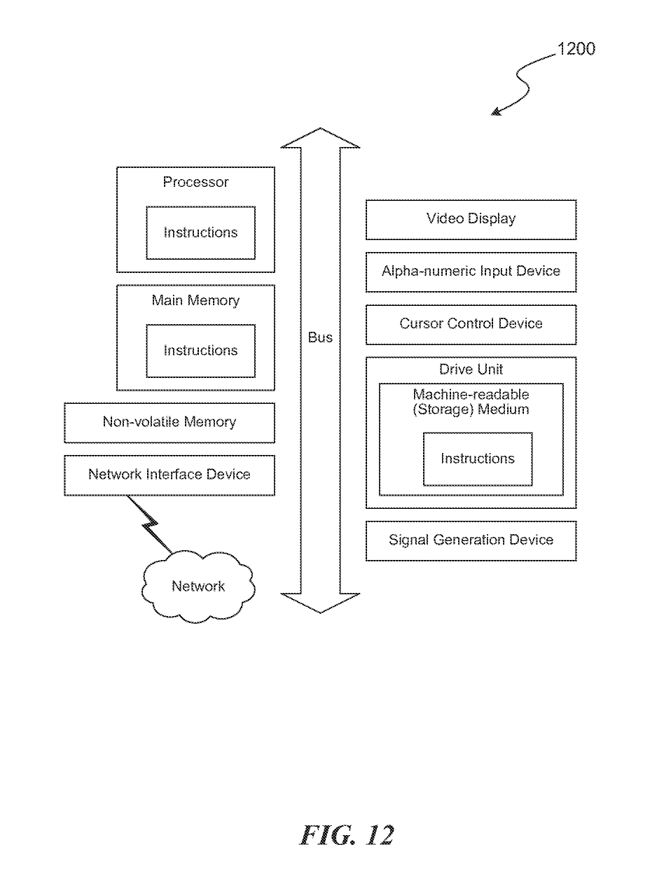

FIG. 12 shows a diagrammatic representation of a machine 1200 in the example form of a computer system within which a set of instructions, for causing the machine to perform any one or more of the methodologies discussed herein, may be executed.

In alternative embodiments, the machine operates as a standalone device or may be connected (e.g., networked) to other machines. In a networked deployment, the machine may operate in the capacity of a server or a client machine in a client-server network environment, or as a peer machine in a peer-to-peer (or distributed) network environment.

The machine may be a server computer, a client computer, a personal computer (PC), a user device, a tablet PC, a laptop computer, a set-top box (STB), a personal digital assistant (PDA), a cellular telephone, an iPhone, an iPad, a Blackberry, a processor, a telephone, a web appliance, a network router, switch or bridge, a console, a hand-held console, a (hand-held) gaming device, a music player, any portable, mobile, hand-held device, or any machine capable of executing a set of instructions (sequential or otherwise) that specify actions to be taken by that machine.

While the machine-readable medium or machine-readable storage medium is shown in an exemplary embodiment to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding or carrying a set of instructions for execution by the machine and that cause the machine to perform any one or more of the methodologies of the presently disclosed technique and innovation.

In general, the routines executed to implement the embodiments of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Further examples of machine-readable storage media, machine-readable media, or computer-readable (storage) media include, but are not limited to, recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

The network interface device enables the machine 1200 to mediate data in a network with an entity that is external to the host server, through any known and/or convenient communications protocol supported by the host and the external entity. The network interface device can include one or more of a network adaptor card, a wireless network interface card, a router, an access point, a wireless router, a switch, a multilayer switch, a protocol converter, a gateway, a bridge, bridge router, a hub, a digital media receiver, and/or a repeater.

The network interface device can include a firewall which can, in some embodiments, govern and/or manage permission to access/proxy data in a computer network, and track varying levels of trust between different machines and/or applications. The firewall can be any number of modules having any combination of hardware and/or software components able to enforce a predetermined set of access rights between a particular set of machines and applications, machines and machines, and/or applications and applications, for example, to regulate the flow of traffic and resource sharing between these varying entities. The firewall may additionally manage and/or have access to an access control list which details permissions including for example, the access and operation rights of an object by an individual, a machine, and/or an application, and the circumstances under which the permission rights stand.

Other network security functions can be performed or included in the functions of the firewall, can be, for example, but are not limited to, intrusion-prevention, intrusion detection, next-generation firewall, personal firewall, etc. without deviating from the novel art of this disclosure.

### Remarks

In general, the routines executed to implement the embodiments of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times. Further, any specific numbers noted herein are only examples: alternative implementations may employ differing values or ranges.

The teachings of the disclosure provided herein can be applied to other systems, not necessarily the system described above. The elements and acts of the various embodiments described above can be combined to provide further embodiments.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

While certain aspects of the disclosure are presented below in certain claim forms, the inventors contemplate the various aspects of the disclosure in any number of claim forms. For example, while only one aspect of the disclosure is recited as a means-plus-function claim under 35 U.S.C. §112, ¶6, other aspects may likewise be embodied as a means-plus-function claim, or in other forms, such as being embodied in a computer-readable medium. (Any claims intended to be treated under 35 U.S.C. §112, ¶6 will begin with the words “means for”.) Accordingly, the applicant reserves the right to add additional claims after filing the application to pursue such additional claim forms for other aspects of the disclosure.

### Computer Program Listing

The following code provides one example implementation of an event-triggering system operating synergistically with ring database information as may be implemented in some embodiments. Applicant retains title in the copyright to the following code. The code is provided here merely for purposes of explanation and should not be considered a dedication to the public.

window.BandMatcherBridge=window.BandMatcherBridge∥(function( ){function
A(C){$(“INPUT[name=‘sAction’]”).val(C.data(“action”));$(“input[name=‘oid’]”).val(C.da
ta(“currentBand”).oid);$(“#ring-action”)[0]. submit( )}function B(F,C,E,D){var
H=$(“#known-ring-size”);if(H.length>0){A(F)}else{C.empty( );var
G=F.data(“currentBand”),I={destination:D,sizes:G.availableSizes};C.html(E(I));C.show(
)}return
false}return{selectRing:B,addToWishList:B,ringSizeChange:A}}( ));(function( ){var
L,P,A,V,U=$(“#rotator-controls”).html( ),S=$(“#selected-engagement-
ring”),Q=$(“#selected-band”),R=$(“.combination-heading”),J=$(“.combination-heading
.pricing .engagement”),D=$(“.combination-heading .pricing .band”),M=$(“.combination-
heading .pricing .total”),N=$(“#ring-size-container”),W=“active”,G=$(“body”);function
T(X){if(X.hasClass(“all”)){X.removeClass(“all”)}else{X.addClass(“all”)}}function
C(X){$(X).removeClass(W)}function I(X){return X.hasClass(“all”)}function
K( ){$(“.choosers.known-ring”).removeClass(“known-
ring”)}G.on(“#style”,function(Y,X){$.ajax({url:X,dataType: “json”,cache:true,success:fu
nction(Z){$(“.choosers”).html(L(Z));T($(“div.settings.container”))}})});G.on(“#styles”,f
unction(Y){var
X=$(“.choosers”);K( );X.empty( );X.html(G.data(“stylesCache”))});G.on(“#setting”,functi
on(Z,Y){var X=$(“#oid-”+Y);C(“.settings.container
li”);X.closest(“li”).addClass(W);G.trigger(“updateSetting”,X.data(“this”));G.trigger(“upd
ateBands”,{bands:X.data(“matchingBands”)})});G.on(“#band”,function(Y,X){var
Z=$(“#oid-”+X);C(“.bands.container
li”);Z.closest(“li”).addClass(W);$(“body”).trigger(“updateBand”,Z.data(“this”))});G.on(“
#similar”,function(Y,X){K( );G.trigger(“#style”,“/band-
matcher/similar/”+X)});G.on(“updateSetting”,function(Y,X){G.trigger(“disableAnimatio
n”);T($ (“div.settings.container.all”));S.empty( );S.append(V(X));S.show( );G.trigger(“upd
atePrice”,{setting:X.price.value})});G.on(“updateBand”,function(Y,X){Q.empty( );Q.app
end(V(X));Q.show( );$(“#band_matcher”).css(“background-
image”,“url(“‘+X.stacker.src+’”)”);G.trigger(“updatePrice”,{band:X.price.value,total:X.to
tal.value});G.data(“currentBand”,X)});G.on(“updateBands”,function(Y,X){$(“body”).trig
ger(“updateBand”,X.bands[0]);$(“.choosers
.bands”).replaceWith(P(X.bands));$(“.choosers .bands
li”).first( ).addClass(W);H( )});G.on(“updatePrice”,function(b,a){var Z=a.setting;var
Y=a.band;var X=a.total;R.show( );if(Z){J.html(“Engagement Ring:
”+Z)}if(Y){D.html(“Wedding Ring: ”+Y)}if(X){M.html(“Total:
”+X)}});G.on(“click”,“a.all.control”,function(Z){if(Z){Z.stopPropagation( )}var
Y=$(this);var
X=Y.closest(“.container”);Y.data(“parent”,X);T(X)});G.on(“click”,‘a[href\hat{ }=“#”]’,function
( ){G.data(“currentAnchor”,$(this))});G.on(“disableAnimation”,function( ){$(“#animation
-container”).remove( );$(“.matcher”). show( )});G.on(“click”,“.add-to-
wishlist”,function( ){G.data(“action”,“favorite”);return
BandMatcherBridge.addToWishList(G,N,A,“wishlist”)});G.on(“click”,“.select-
ring”,function( ){G.data(“action”,“basket”);return
BandMatcherBridge.selectRing(G,N,A,“basket”)});G.on(“change”,“#ring-size-
selector”,function(Y,X){BandMatcherBridge.ringSizeChange(G)});G.on(“click”,“.alert-
close”,function(Z,Y){var X=$(this).closest(“.closable”);X.hide( );X.empty( )});function
B( ){$(“#animation-container”).addClass(“animate”)}function
F( ){Handlebars.registerHelper(“json”,function(X){return
JSON.stringify(X)});Handlebars.registerHelper(“plural”,function( ){var
Y=arguments[2],X=Array.prototype.slice.call(arguments),Z=X.slice(2,-1);function
a( ){return this.replace(/{( \d+)}/g,function(b,c){return typeof
Z[c]!==“undefined”?Z[c]:b})}return
a.call(Y===1?arguments[0]: arguments[1])});L=Handlebars.compile($(“#settings-
template”).html( ));P=Handlebars.compile($(“#bands-
template”).html( ));A=Handlebars.compile($(“#select-
size”).html( ));V=Handlebars.compile($(“#ring-detail-
template”).html( ));Handlebars.registerPartial(“bands”,P)}function O(Y,e,X,a,c,Z){var
f=$(Y),d=a*Z,b=c*Z;return function( ){var
h=f.position( ).left,g=h+d;console.log(g);console.log(g*Z,c,g*Z>=c);if(g*Z>=c){g=b;e.da
ta(“disable”).apply( )}console.log(“moving”,g,a,c,Z);f.animate({left: g+“px”},1000);X.dat
a(“enable”).apply( )}}function H( ){function Y(h){h=$(h);return
function( ){if(h.data(“isEnabled”)){h.removeClass(“more”);h.off(“click”);h.data(“isEnabl
ed”,false)}}}function d(i,h){i=$(i);return
function( ){if(!i.data(“isEnabled”)){i.addClass(“more”);i.on(“click”,h);i.data(“isEnabled”,t
rue)}}}var 1=$(“.rotator-container”);function c(z,u,AA,x){var v;var t=z[u];var y=z [1-
u];var s=u===0;var j=s?1:-1;var h=AA.width( );if(h===0){v=s?15:0+x}else{v=s?15:h-
x}var
w=d(t,O(AA,t,y,x,v,j));t.data(“enable”,w);t.data(“disable”,Y(t));if(u===1){w.apply( )}}fo
r(var m=0;m<2;m++){var
e,g,k,r,q,b,Z,o,a,f;q=$(1[m]);if(!q.data(“rotatable”)){b=q.find(“li”);Z=b.length;o=-
1;a=b.first( ).outerWidth(true);f=m===0?5:3;for(var p=0;p<Z;p++){var
X=$(b[p]);o=X.hasClass(“active”)?p:o;if(o>-
1){break}}r=f<Z;q.data(“rotatable”,r);k=q.children(“ul”).first( );if(r){g=a*f;q.append(U);
e=[q.children(“.previous”).first( ),q.children(“.next”).first( )];for(var
n=0;n<2;n++){c(e,n,k,g)}}}}}$(document).ready(function( ){var
Y,a=$(“#band_matcher”).data(“setting”),X=$(“.choosers”);X.hide( );if(location.hash){var
Z=E( );if(Z[0]===“#setting”){window.location.href=“/hand-
matcher/landing/”+Z[1]}}G.data(“stylesCache”,X.html( ));F( );if(a){Y={settings:[a]};X.ht
ml(L(Y));G.trigger(“#setting”,a.oid)}X.show( )});function E( ){return
window.location.hash.split(“!”)}$(window).load(function( ){B( );$(window).on(“hashchan
ge”,function(Y){var X=E( );G.trigger(X[0],X.slice(1))})})}( ));

1. A computer system comprising:
a network interface configured to communicate with a user device;
at least one memory comprising instructions configured to be received via software on the user device, and wherein the instructions are executable by at least one processor on the user device, to:
receive a selection of a primary ring style from a user;
identify a plurality of compatible secondary ring styles based on the selected primary ring style, the secondary ring styles selected from a dataset that contains:
a correspondence between the primary ring style and a plurality of compatible secondary ring styles; and
a plurality of images, each of the plurality of images depicting the primary ring style and a different one of the plurality of compatible secondary ring styles as they would appear adjacent to one another on a user's hand;
generate a display for the user, the display comprising:
a primary ring display region that displays the selected primary ring style; and
a secondary ring display region that displays at least some of the plurality of secondary ring styles that are compatible with the primary ring style;
receive a user selection of a compatible secondary ring style; and
update the display for the user, based in part on the dataset, such that the display further includes a combination display region, the combination display region including an image of the selected primary ring style and the selected compatible secondary ring style as they would appear on a user's hand.

2. The computer system of claim 1, wherein the instructions are further executable by the at least one processor on the user device to cause the user device to display an interface comprising a “ghost” icon directing the user how to provide an input.

3. The computer system of claim 1, wherein the display for the user further comprises:
a price display region displaying a combined price of the selected primary ring style and the selected compatible secondary ring style.

4. The computer system of claim 3, wherein the instructions comprise JAVASCRIPT and wherein the dataset comprises a JSON object.

5. The computer system of claim 1, wherein the primary ring style is an engagement ring and the secondary ring style is a wedding ring.

6. The computer system of claim 3, wherein the secondary ring display region is configured to update following a selection of a new secondary ring style by the user, the update comprising:
depicting a new image of the selected primary ring style and the newly selected compatible secondary ring style; and
modifying the price display region to reflect the price of the selected primary ring style and the newly selected compatible secondary ring style.

7. The computer system of claim 6, wherein the first update is configured to cause a third update, the third update configured to stop a perspective animation of the primary ring style.

8. A computer-implemented method for presenting element information comprising:
receiving, at a computer system, a selection of a primary ring style from a user;
identifying, at the computer system, a plurality of compatible secondary ring styles based on the selected primary ring style, the secondary ring styles selected from a dataset that contains:
a correspondence between the primary ring style and a plurality of compatible secondary ring styles; and
a plurality of images, each of the plurality of images depicting the primary ring style and a different one of the plurality of compatible secondary ring styles as they would appear adjacent to one another on a user's hand;
generating a display for the user, the display comprising:
a primary ring display region that displays the selected primary ring style; and
a secondary ring display region that displays at least some of the plurality of secondary ring styles that are compatible with the primary ring style;
receiving, at the computer system, a user selection of a compatible secondary ring style; and
updating, at the computer system, the display for the user, based in part on the dataset, such that the display further includes a combination display region, the combination display region including an image of the selected primary ring style and the selected compatible secondary ring style as they would appear on a user's hand.

9. The computer-implemented method of claim 8, wherein generating a display for the user comprises:
generating a price display region displaying a combined price of the selected primary ring style and the selected compatible secondary ring style; and
wherein the combination display region is configured to trigger an update event in the price display region following an update event at the combination display region.

10. The computer-implemented method of claim 9, wherein identifying, at the computer system, a plurality of compatible secondary ring styles comprises running JAVASCRIPT instructions, and wherein the dataset comprises a JSON object.

11. The computer-implemented method of claim 8, wherein the primary ring style is an engagement ring and the secondary ring style is a wedding ring.

12. The computer-implemented method of claim 9, wherein the secondary ring display region is configured to update following a selection of a new secondary ring style by the user, the update comprising:
depicting a new image of the selected primary ring style and the newly selected compatible secondary ring style: and
modifying the price display region to reflect the price of the selected primary ring style and the newly selected compatible secondary ring style.

13. The computer-implemented method of claim 12, wherein the first update is configured to cause a third update, the third update configured to stop a perspective animation of the primary ring style.

14. A non-transitory computer-readable medium comprising instructions executable by one or more processors to cause a computer system to:
receive a selection of a primary ring style from a user;
identify a plurality of compatible secondary ring styles based on the selected primary ring style, the secondary ring styles selected from a dataset that contains:
a correspondence between the primary ring style and a plurality of compatible secondary ring styles; and
a plurality of images, each of the plurality of images depicting the primary ring style and a different one of the plurality of compatible secondary ring styles as they would appear adjacent to one another on a user's hand;
generate a display for the user, the display comprising:
a primary ring display region that displays the selected primary ring style; and
a secondary ring display region that displays at least some of the plurality of secondary ring styles that are compatible with the primary ring style;
receive a user selection of a compatible secondary ring style; and
update the display for the user, based in part on the dataset, such that the display further includes a combination display region, the combination display region including an image of the selected primary ring style and the selected compatible secondary ring style as they would appear on a user's hand.

15. The non-transitory computer-readable medium of claim 14, wherein the non-transitory computer-readable medium is located on a memory in a server.

16. The non-transitory computer-readable medium of claim 14, wherein to generate a display for the user comprises:
generating a price display region displaying a combined price of the selected primary ring style and the selected compatible secondary ring style; and wherein
the combination display region is configured to trigger an update event in the price display region following an update event at the combination display region.

17. The non-transitory computer-readable medium of claim 16, wherein the instructions comprise JAVASCRIPT and wherein the dataset comprises a JSON object.

18. The non-transitory computer-readable medium of claim 14, wherein the primary ring style is an engagement ring and the secondary ring style is a wedding ring.

19. The non-transitory computer-readable medium of claim 16, wherein the secondary ring display region is configured to initiate at least a portion of an event cascade following a selection of a new secondary ring style by the user, the event cascade comprising a plurality of updates, wherein
a first update of the plurality of updates causes the combination display to depict a new image of the selected primary ring style and the newly selected compatible secondary ring style, the combination display causing a second update in the price display region based upon the first update, and
the second update configured to modify the price display region to reflect the price of the selected primary ring style and the newly selected compatible secondary ring style.

20. The non-transitory computer-readable medium of claim 19, wherein the first update is configured to cause a third update, the third update configured to stop a perspective animation of the primary ring style.

21. The computer system of claim 6, wherein an associated secondary ring list in the dataset corresponds to a secondary ring style ID, and the secondary ring style id in the dataset corresponds to a combined price and to a combined image for display in the combination display.
